(19) United States
(12) Patent Application Publication
(10) Pub. No.: US 2026/0336288 A1
(43) Pub. Date: Oct. 29, 2026

(54) RECORDING ELEMENT SUBSTRATE AND METHOD FOR MANUFACTURING THE SAME

(71) Applicant: CANON KABUSHIKI KAISHA, Tokyo (JP)

(72) Inventors: MAI HIROHARA, Kanagawa (JP); TAKERU YASUDA, Kanagawa (JP); YUZURU ISHIDA, Kanagawa (JP); SHINYA IWAHASHI, Kanagawa (JP)

(21) Appl. No.: 19/658,276

(22) Filed: Apr. 24, 2026

(30) Foreign Application Priority Data
Apr. 28, 2025 (JP) 2025-074591

(51) Int. Cl. B41J 2/14; B41J 2/16

(52) U.S. Cl. CPC B41J 2/14129; B41J 2/14072; B41J 2/1603; B41J 2/1628; B41J 2/1646

(57) ABSTRACT

A recording element substrate includes a discharge port configured to discharge a liquid to perform recording on a recording medium, a substrate including a supply port configured to supply the liquid to the discharge port, a heating element configured to heat the liquid to discharge the liquid from the discharge port, a protective layer on the heating element, and wiring electrically connected to the protective layer. The protective layer and the wiring are α-phase tantalum.

### BACKGROUND

### Field of the Technology

The present disclosure relates to a recording element substrate and a method for manufacturing the recording element substrate.

### Description of the Related Art

Examples of typical recording heads used in recording operations include a liquid discharge head (also referred to as a recording head for inkjet) that performs a recording operation by discharging a liquid, and a thermal recording head employing a thermal transfer method.

An energy generation element used in such a recording head includes a heat generating resistive layer that generates heat when supplied with power and a pair of electrodes used to supply power to the heat generating resistive layer. In a recording head for inkjet, applying a voltage to the pair of electrodes causes the heat generating resistive layer to generate heat and thereby causes a liquid to foam. The pressure of the resulting bubbles discharges the liquid from discharge ports to perform a recording operation.

Such an energy generation element is coated with an insulation layer made of an insulating material. It is known that a cavitation-resistant layer made of tantalum or the like is further provided on the insulation layer to protect the energy generation element from mechanical shock and chemical effect.

Crystal structures of tantalum include a body-centered cubic crystal structure (also referred to as the β phase) widely used in the field of inkjet, and a close-packed cubic crystal structure (also referred to as the α phase). An α-phase tantalum layer exhibits higher thermal and electrical conductivities and greater crystalline stability than a β-phase tantalum layer. Therefore, the use of the α-phase tantalum layer as an cavitation-resistant layer has been considered.

In general, forming a high-quality α-phase tantalum layer requires a high-performance vacuum system having a pressure of less than 1.33×10⁻⁵ Pa (10⁻⁷ Torr), a high deposition rate exceeding 1 nanometer per second, and a high substrate temperature higher than 300 °C. By contrast, a β-phase tantalum layer is generally formed at higher pressure (i.e., poor vacuum), a lower deposition rate, and a lower substrate temperature.

Japanese Patent Laid-Open No. 2005-298975 describes a method in which tantalum is formed after forming a buffer layer to cause tantalum on the buffer layer to undergo a phase transition into α-phase tantalum.

However, in a case where a recording element substrate used for a liquid discharge head is manufactured using the method described in Japanese Patent Laid-Open No. 2005-298975, an additional process of forming a buffer layer is required to use an α-phase tantalum layer as a cavitation-resistant layer. Further, because the thickness of the cavitation-resistant layer increases by an amount corresponding to the buffer layer, thermal efficiency decreases. In addition, in a case where a wiring layer connected to an electrode pad portion for electrically connecting the cavitation-resistant layer to the outside is formed in the same tantalum layer, the wiring layer is also desired to be an α-phase tantalum layer having high electrical conductivity. However, the presence of the buffer layer increases electrical resistance by a corresponding amount.

### SUMMARY

The present disclosure has been made in view of the above disadvantages, and the present disclosure is directed to providing a recording element substrate of a liquid discharge head in which an α-phase tantalum layer is formed without using a buffer layer.

According to an aspect of the present disclosure, a recording element substrate includes a discharge port configured to discharge a liquid to perform recording on a recording medium, a substrate including a supply port configured to supply the liquid to the discharge port, a heating element configured to heat the liquid to discharge the liquid from the discharge port, a protective layer on the heating element, and wiring electrically connected to the protective layer, wherein the protective layer and the wiring are α-phase tantalum.

Features of the present disclosure will become apparent from the following description of embodiments with reference to the attached drawings. The following description of embodiments is described by way of example.

### BRIEF DESCRIPTION OF THE DRAWINGS

FIGS. 1A and 1B are a perspective view and a cross-sectional view, respectively, schematically illustrating a recording element substrate.

FIGS. 2A to 2E are diagrams for illustrating a method for manufacturing a recording element substrate.

### DESCRIPTION OF THE EMBODIMENTS

Embodiments of the present disclosure will be described in detail below.

### First Embodiment

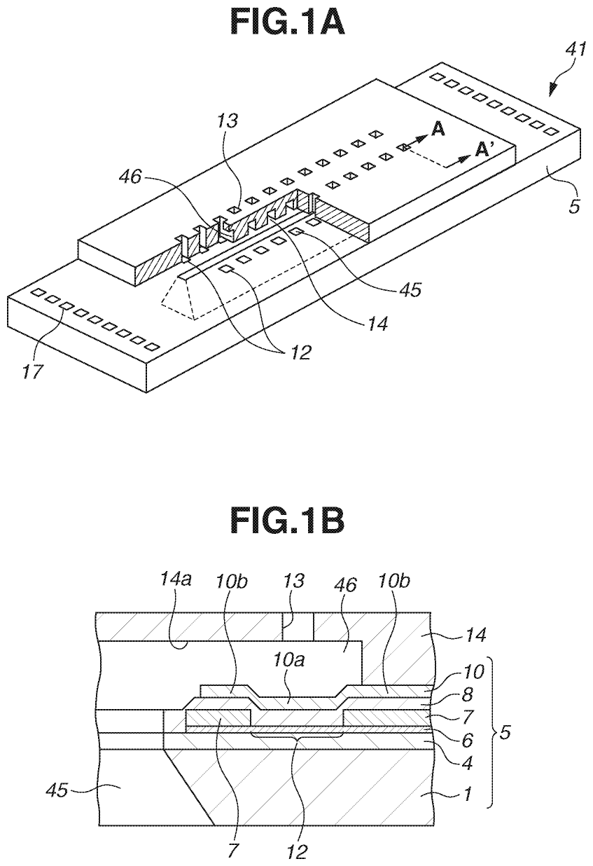

FIG. 1A is a perspective view illustrating a recording element substrate 41 used for a liquid discharge head according to a first embodiment. FIG. 1B is a cross-sectional view schematically illustrating a cross section of the recording element substrate 41 taken along line A-A′ of FIG. 1A. The recording element substrate 41 includes a substrate 5 including energy generation elements (heating elements) 12 that generate thermal energy used to discharge a liquid, and flow path forming members 14 disposed on the substrate 5. The liquid is discharged from discharge ports, thus performing recording on a recording medium. The energy generation elements are arranged at a density of about 1200 dots per inch (dpi). Each flow path forming members 14 can be made of a cured material of a thermosetting resin, such as an epoxy resin, and includes a discharge port 13 for discharging a liquid and a wall 14a of a flow path 46 that communicates with the discharge port 13. The flow path 46 is defined by the wall 14a as an inner wall and by the flow path forming member 14 in contact with the substrate 5.

The discharge ports 13 provided in the flow path forming members 14 are arranged so as to form an array at a predetermined pitch along supply ports 45. The liquid supplied from the supply ports 45 is conveyed to the flow paths 46. Thermal energy generated by the energy generation elements 12 causes the liquid to undergo film boiling, thereby generating bubbles. The pressure generated at this time discharges the liquid from the discharge ports 13, thereby performing a recording operation. The recording element substrate 41 further includes liquid supply ports 45 penetrating through the substrate 5 to supply the liquid to the flow paths 46, and electrode pad portions 17 for electrical connection with an external device, for example, a liquid discharge apparatus. Supplying a voltage from the external device to the electrode pad portions 17 enables supplying power to the energy generation elements 12 and enables discharging the liquid.

In a cross-sectional view of the recording element substrate 41, as illustrated in FIG. 1B, a heat accumulation layer 4 made of a silicon compound is provided on a base 1 made of silicon in which drive elements, such as transistors (not illustrated), are provided. A heat generating resistive layer 6 made of a material that generates heat when supplied with power (e.g., tantalum silicon nitride (TaSiN) or tungsten silicon nitride (WSiN)) is disposed on the heat accumulation layer 4. A pair of electrodes 7 made mainly of a material having lower resistance than that of the heat generating resistive layer 6, such as aluminum, is disposed so as to be in contact with the heat generating resistive layer 6. Supplying a voltage between the pair of electrodes 7 heats a portion of the heat generating resistive layer 6 located between the pair of electrodes 7, so that the portion of the heat generating resistive layer 6 is used as the energy generation element 12. The heat generating resistive layer 6 and the pair of electrodes 7 are coated with an insulation layer 8 made of an insulating material, such as a silicon compound (e.g., SiN), to achieve insulation from a liquid used for discharge, such as ink.

Further, to protect the energy generation element 12 from a cavitation impact accompanying foaming and contraction of the liquid for discharge, a cavitation-resistant layer is provided on the insulation layer 8 in a portion corresponding to the energy generation element 12. As the cavitation-resistant layer, a conductive layer (also referred to as a metal protective layer) 10 made of tantalum is formed. In other words, a conductive layer is formed on the heating element. The conductive layer 10 includes a region 10a, which corresponds to an upper side of the energy generation element 12 and is used as the cavitation-resistant layer, and a region 10b serving as a wiring layer (also referred to as wiring) that connects the cavitation-resistant layer and the electrode pad portions 17. The conductive layer 10 is formed, in both the regions 10a and 10b, of single-layer α-phase tantalum (hereinafter, also referred to as “α-Ta”).

Here, α-Ta is a stable phase having a close-packed cubic crystal structure, and has higher thermal conductivity and higher electrical conductivity than β-Ta, which is a quasi-stable phase having a body-centered cubic crystal structure. High thermal conductivity is required in the region 10a corresponding to an upper side of the energy generation element 12 and high electrical conductivity is required in the region 10b used as a wiring layer. Thus, it is most desirable that both regions be formed of a single-layer α-Ta layer.

An example of a method for forming the conductive layer 10 will be described. In general, argon (Ar) is used as an inert gas used in sputtering. In Ar sputtering, when Ar ions sputter Ta atoms from a target, the Ar ions obtain electrons from the target to be neutralized and rebound toward a substrate with high energy (recoil Ar). This recoil Ar inhibits crystalline growth of a film, and thus, a metastable β-Ta is formed rather than stable α-Ta. The recoil energy is calculated by the following formula.

$$Recoil energy = \frac{{( \begin{matrix}Atomic weight of target atom - \\ Atomic weight of sputtering - gas atom\end{matrix} )}^{2}}{{( \begin{matrix}Atomic weight of target atom + \\ Atomic weight of sputtering - gas atom\end{matrix} )}^{2}} \times Target atom$$

In other words, the recoil energy can be reduced by using a noble gas having an atomic weight larger than that of Ar and close to that of Ta, such as xenon (Xe), krypton (Kr), or radon (Rn). This enables forming α-Ta on an arbitrary substrate without using a buffer layer and without requiring special conditions such as high temperature and high vacuum. As illustrated in FIG. 1B, the heating element, the insulation layer, and the protective layer are stacked in close contact in this order.

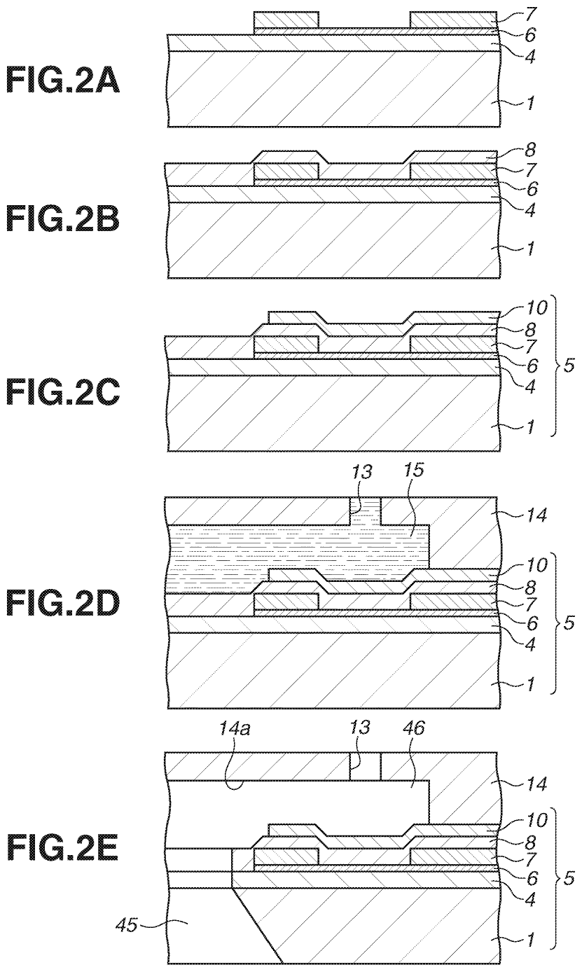

A manufacturing process in a method for manufacturing such a recording element substrate will be specifically described below with reference to the drawings. FIGS. 2A to 2E are cross-sectional views schematically illustrating a cross section of the recording element substrate 41 taken along line A-A′ of FIG. 1A in respective steps. Referring to FIG. 2A, a base 1 made of silicon is prepared. The base 1 is provided with drive elements (not illustrated), such as metal-oxide-semiconductor (MOS) transistors used to drive the energy generation elements 12. Further, a heat accumulation layer 4 is disposed on the base 1. The heat accumulation layer 4 is made of silicon oxide (SiO₂) and is formed with a film thickness of about 0.5 μm to about 3 μm by chemical vapor deposition (CVD) or the like.

The heat generating resistive layer 6 and a wiring layer to be the pair of electrodes 7 are formed on the heat accumulation layer 4 by sputtering. The heat generating resistive layer 6 is made of a material that generates heat when supplied with power, such as TaSiN or WSiN, and has a film thickness of about 10 nm to about 50 nm. The wiring layer is made mainly of aluminum and has a film thickness of about 0.1 μm to about 1 μm. Further, the heat generating resistive layer 6 and the wiring layer are patterned using a dry etching technique, such as reactive ion etching (RIE). Then, a portion of the wiring layer is removed using a wet etching technique or a dry etching technique to form the pair of electrodes 7. A portion of the heat generating resistive layer 6 corresponding to a portion where the wiring layer is removed is used as an energy generation element 12 (FIG. 2A).

Next, an insulation layer 8 having insulating properties and made of silicon nitride (SiN) or the like is formed on the entire surface of the substrate with a film thickness of about 100 nm to about 1 μm using chemical vapor deposition (CVD) or the like so as to cover the heat generating resistive layer 6 and the pair of electrodes 7 (FIG. 2B).

Next, a conductive layer 10 made of α-phase tantalum (Ta) is formed on the insulation layer 8 with a film thickness of about 50 nm to about 500 nm using a vacuum magnetron sputtering method. The vacuum magnetron sputtering method uses noble gas atoms as an inert gas. In the present embodiment, krypton gas (Kr gas) is used, and sputtering is performed at room temperature using a pressure of 1.83 Pa and power of 50 W. Tantalum is used as a target material. Further, the conductive layer 10 is patterned using a dry etching technique such as RIE. This forms the conductive layer 10a serving as a protective material layer having durability for protection from a cavitation impact accompanying foaming and contraction of the liquid, and the conductive layer 10b serving as a wiring layer connected to the electrode pad portions 17. That is, the wiring is electrically connected to the electrode pad portions 17. By the above-described method, the conductive layer 10 includes krypton atoms inside.

Next, using a vacuum film deposition apparatus or the like, an adhesion improving layer (barrier metal) made of a high-melting-point material such as TiW, and a gold (Au) layer serving as a plating conductor, are formed on the entire surface to predetermined thicknesses.

Thereafter, a soluble resin, (e.g., a photoresist) is formed on a surface of the gold layer serving as the plating conductor by spin coating, and the resin is patterned using a photolithography technique.

Thereafter, by electrolytic plating, a predetermined current is applied to the gold layer serving as the plating conductor in an electrolytic bath of sulfite gold salt to deposit gold in a predetermined region not covered by the photoresist, thereby providing the electrode pad portions 17.

Next, a soluble resin is formed on the surface of the substrate 5 by spin coating, and the resin is patterned using a photolithography technique to form a mold material 15 in a portion that becomes the flow path 46. More specifically, polymethyl isopropenyl ketone or the like can be used. Further, a cationically polymerizable epoxy resin is formed on the mold material 15 by spin coating, and is then baked using a hot plate to cure the epoxy resin, thereby forming the flow path forming member 14. Thereafter, a portion of the flow path forming member 14 that becomes the discharge port 13 is removed using a photolithography technique (FIG. 2D).

Next, using a tetramethylammonium hydroxide solution (TMAH solution) or the like, the base 1 made of silicon is etched from a rear surface opposite a surface on which the energy generation element 12 is provided, thereby forming a through opening that serves as the supply port 45. When a single-crystal silicon substrate having a surface crystal orientation of a (100) plane is used as the base 1, the supply port 45 can be formed by crystal anisotropic etching using an alkaline solution (e.g., a TMAH solution).

In such a base 1, because an etching rate of a (111) plane is extremely slow compared with etching rates of other crystal planes, the supply port 45 can be formed so as to form an angle of about 54.7 degrees with respect to a plane of the silicon substrate. Thereafter, when the mold material 15 is removed, the flow path forming member 14 having the discharge port 13 and the wall 14a of the flow paths 46 is completed on the substrate 5 provided with the energy generation element 12 and the supply port 45 (FIG. 2E). The supply ports 45 may be formed not only by wet etching but also by dry etching.

As described above, manufacturing, without using a buffer layer, an α-phase tantalum cavitation-resistant layer and an α-phase tantalum wiring layer connected to the electrode pad portions 17 can eliminate a film formation process for the buffer layer. Further, because the film thickness of the cavitation-resistant layer becomes thinner by an amount corresponding to the absence of the buffer layer, thermal efficiency is improved. In addition, the electrical resistance of the wiring layer can be reduced. Thus, a highly reliable and energy-saving liquid discharge head can be provided without an additional process.

### Example 1

The crystalline state of tantalum was examined in the substrate 5 in which a 50 nm conductive layer 10 made of tantalum was formed using Kr gas as a process gas during sputtering.

Using electron backscatter diffraction (EBSD) analysis, a crystal orientation and a crystal system at a micro level were measured. A peak intensity of α(110) was 50 times that of β(002), confirming formation of an almost single-phase α-Ta.

By contrast, in a tantalum film formed using Ar gas as a dilution gas during sputtering, only the β(002) peak was observed, and formation of a single-layer β-Ta was confirmed.

### Example 2

Next, thermal conductivity and electrical conductivity were compared between a recording element substrate including α-Ta and a recording element substrate including β-Ta, each prepared by the method described in Example 1. It was confirmed that α-Ta had higher thermal conductivity and higher electrical conductivity than β-Ta. The improvement in thermal conductivity enables efficiently transmitting, to the liquid, heat generated by a heat generating resistor in a region covering the heat generating resistor. Further, the improvement in electrical conductivity enables reducing electrical resistance in a region connected to the electrode pad portion 17 and used as a wiring layer.

According to the present disclosure, it is possible to provide a recording element substrate of a liquid discharge head in which an α-phase tantalum layer is formed without using a buffer layer.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-074591, filed Apr. 28, 2025, which is hereby incorporated by reference herein in its entirety.

What is claimed is:

1. A recording element substrate comprising:
a discharge port configured to discharge a liquid to perform recording on a recording medium;
a substrate including a supply port configured to supply the liquid to the discharge port;
a heating element configured to heat the liquid to discharge the liquid from the discharge port;
a protective layer on the heating element; and
wiring electrically connected to the protective layer,
wherein the protective layer and the wiring are α-phase tantalum.

2. The recording element substrate according to claim 1, further comprising an insulation layer configured to electrically insulate the heating element from the protective layer,
wherein the heating element, the insulation layer, and the protective layer are stacked in close contact in this order.

3. The recording element substrate according to claim 1, further comprising an electrode pad portion for external electrical connection,
wherein the wiring is electrically connected to the electrode pad portion.

4. The recording element substrate according to claim 1, wherein the protective layer includes, therein, noble gas atoms having an atomic weight greater than that of argon.

5. The recording element substrate according to claim 4, wherein the noble gas atoms are krypton atoms.

6. The recording element substrate according to claim 4, wherein the noble gas atoms are xenon atoms.

7. A method for manufacturing a recording element substrate including a discharge port configured to discharge a liquid to perform recording on a recording medium, a substrate including a supply port configured to supply the liquid to the discharge port, a heating element configured to heat the liquid to discharge the liquid from the discharge port, and an insulation layer on the heating element, the method comprising:
forming, by a sputtering method, a protective layer on the insulation layer and wiring electrically connected to the protective layer,
wherein, in forming the protective layer and the wiring by the sputtering method, tantalum is used as a target material and a noble gas having atoms with an atomic weight greater than that of argon is used as an inert gas.

8. The method for manufacturing a recording element substrate according to claim 7, wherein the protective layer and the wiring formed by the sputtering method are α-phase tantalum.

9. The method according to claim 7, wherein the inert gas is krypton.

10. The method according to claim 7, wherein the inert gas is xenon.
